(19) United States
(12) Patent Application Publication
(10) Pub. No.: US 2004/0109433 A1
(43) Pub. Date: Jun. 10, 2004

(54) Reverse link packet acknowledgement method

(76) Inventor: Farooq Ullah Khan, Manalapan, NJ (US)

Correspondence Address: HARNESS, DICKEY & PIERCE, P.L.C., P.O. Box 8910, Reston, VA, 20195, US

(21) Appl. No.: 10/310,769

(22) Filed: Dec. 6, 2002

(51) Int. Cl. H04J 3/00

(52) U.S. Cl. 370/345; 370/230.1

(57) ABSTRACT

In this method of managing packet transmission by a mobile, a forward control channel that includes scheduling information and acknowledgement information is transmitted. The scheduling information schedules transmission by a mobile and the acknowledgement information indicates successful or unsuccessful receipt of at least one packet sent by the mobile. A mobile then determines whether to transmit based on the scheduling information and determines whether to transmit a new packet or retransmit a previously sent packet based on the acknowledgement information.

### BACKGROUND OF THE INVENTION

In the evolving wireless data systems, such as the well-known 1×-EV-DO and 1×EV-DV standards as well as the High Speed Downlink Packet Access (HSDPA) specification in the Universal Mobile Telecommunication System (UMTS) standard (often collectively referred to as 3G standards), the forward link (base station to mobile station(s)) capacity has been increased by using techniques such as fast scheduling, adaptive modulation and coding (AMC) and hybrid ARQ (HARQ). In general, a scheduler, for example in the base station, selects a user for transmission at a given time and adaptive modulation and coding allows selection of the appropriate transport format (modulation and coding) for the current channel conditions seen by the user. Due to errors in channel quality estimates, high error rates result in the transmissions performed at a given rate (transport format). Hybrid ARQ, which makes use of fast retransmissions and combining a newly received copy of the transmission with the previously received copies, allows for recovery from transmission errors.

Further evolution of 3G standards includes high-speed reverse link (mobile station to base station) packet access. Most of the techniques used on the forward link (also referred to as the downlink) like fast scheduling, AMC and HARQ can also be used on the reverse link (also referred to as the uplink) to improve the data rates and the system capacity. In order to support the HARQ operation on the forward link, an acknowledgement/negative-acknowledgement (ACK/NACK) channel is needed on the reverse link in order to provide feedback about whether a packet was successfully or unsuccessfully received. Similarly, for HARQ operation on the reverse link, an ACK/NACK channel is used on the forward link in order to support the reverse link HARQ operation.

### SUMMARY OF THE INVENTION

In the method according to the present invention, the forward control channel for scheduling transmission by mobiles over the reverse link is also used to supply acknowledgement information regarding packets sent by those mobiles on the reverse link. This eliminates the need for a separate ACK/NACK channel. Furthermore, a more reliable acknowledgement/negative-acknowledgement feedback transmission is provided because the feedback information can be coded along with the other forward control channel information.

In one exemplary embodiment, the scheduling information identifies which mobile is scheduled to transmit by including the mobile identifier for the scheduled mobile in the forward control channel transmission. Acknowledgement information is also generated and included in the forward control channel in association with the mobile identifier. The acknowledgement information indicates whether at least one packet transmitted on the reverse link by the mobile was successfully or unsuccessfully received.

A mobile station determines that acknowledgement information is directed to that mobile when the acknowledgement information is associated with its mobile identifier. If the acknowledgement information indicates negative-acknowledgement (sometimes also referred to as a non-acknowledgement), the mobile retransmits the negatively-acknowledged packet. If the acknowledgement information indicates acknowledgement, the mobile transmits a new packet if the mobile has a packet to send. The transmission (new transmission or retransmission) by the mobile on the reverse link is performed in accordance with the scheduling information received on the forward control channel. In this manner, the acknowledgement information also serves as further or secondary scheduling information by scheduling new transmissions and retransmissions.

In another exemplary embodiment, the acknowledgement information indicates to which of more than one packet transmission channel used by the mobile that the acknowledgement information pertain. In yet another embodiment, the acknowledgement information provides acknowledgement information for more than one packet transmitted on the same packet transmission channel. The acknowledgement information provides these indications either explicitly or implicitly based on the format of the acknowledgement information. Accordingly, the methodology according to the present invention provides considerable flexibility to the system designer.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a communication sequence between a base station and a mobile station according to a prior art acknowledgement/negative-acknowledgement methodology for explaining how HARQ buffer corruption can occur;

FIG. 2 illustrates a communication sequence between a base station and mobile station according to the prior art acknowledgement/negative-acknowledgement methodology for explaining how bandwidth waste can occur;

FIG. 3 illustrates an example of reverse link scheduling on the well-known R-SCH (reverse supplemental channel);

FIGS. 4-6 each illustrate an example of a communication sequence according to a different exemplary embodiment of the acknowledgement/negative-acknowledgement methodology according to the present invention; and

FIG. 7 illustrates a format of the acknowledgement feedback field according to another exemplary embodiment of the acknowledgement/negative-acknowledgement methodology according to the present invention.

### DETAILED DESCRIPTION

Having a dedicated acknowledgement/negative-acknowledgement (ACK/NACK) channel on the forward link to support a HARQ operation on the reverse link has some drawbacks. Additional code space (bandwidth) and power for a separate ACK/NACK channel is required. A large number of error cases (e.g., a NACK sent by the base station being interpreted as an ACK) lead to degraded throughput either due to Hybrid ARQ buffer corruption or unnecessary retransmissions. Unreliable ACK/NACK transmissions can occur because a single-bit ACK/NACK feedback message cannot use any type of channel coding.

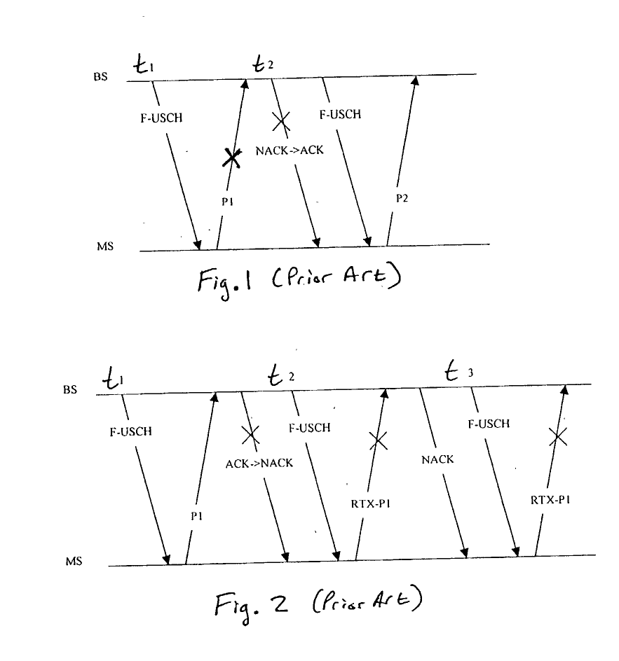

An example of how HARQ buffer corruption occurs when a NACK sent by the base station is considered an ACK at the mobile station is shown in FIG. 1. As shown, at time t1, the base station (BS) transmits a forward uplink scheduling channel (F-USCH). As is known, the forward uplink scheduling channel provides scheduling information to the mobile stations (MS) being served by the base station. More specifically, the scheduling information provides identifiers of mobile stations in particular time slots of the F-USCH such that, in response to receiving their identifiers in particular time slots of the F-USCH, the mobile stations transmit packets in associated time slots on the reverse link. In this manner the base station schedules when a particular mobile station transmits to the base station. It is through this well-known scheduling function that the base station can reduce interference between mobiles, etc.

As shown in FIG. 1, a mobile station scheduled to transmit, transmits a packet P1. If the packet is not successful received (e.g., received but not properly decoded), a NAK is sent over the ACK/NACK forward link channel to the mobile station. If the NACK is received as an ACK at the mobile station, then the mobile station will consider the packet P1 successfully transmitted. As a result, the re-transmission buffer at the mobile station, which stores the packet P1 in case re-transmissions are required, is cleared.

Also at time t2, the base station again schedules transmission by the mobile station. The mobile station will then transmit a new packet P2 instead of re-transmitting the previous packet P1. However, the base station expects a re-transmission of packet P1; and therefore, combines the received packet P2 with the previously unsuccessfully received version of packet P1 according to the HARQ protocol. This then corrupts packet P2 (referred to as HARQ buffer corruption). As a result the base station does not receive the packet P1 or packet P2 correctly.

Packets are typically transmitted with a sequence number, and the sequence numbers increment by a fixed amount. Accordingly, the base station can determine that it has failed to receive packet P1 because of the gap in the received packet sequence numbers that is created by the failure to receive packet P1. However, even if the base station then requests retransmission of packet P1 (e.g., by using the sequence number of packet P1), the mobile station may be unable to send this packet because the packet was cleared from the re-transmission buffer.

As shown in FIG. 2, when an ACK sent by the base station is received as a NACK at the mobile station, this error results in wasted bandwidth because a packet is re-transmitted unnecessarily. Because the ACK/NACK messages on the ACK/NACK channel are typically one-bit messages, and error coding cannot be performed on such messages, ACK/NACK errors such as described above are likely to occur.

The present invention provides a new acknowledgement/negative-acknowledgement methodology for the reverse link that uses the forward control channel (e.g., the forward uplink scheduling channel (F-USCH)) transmitted by the base station to schedule transmission by mobile stations on the reverse link to also supply the acknowledgement/negative-acknowledgment information regarding packets transmitted by mobile stations on the reverse link. For the purposes of explanation only, the embodiments of the acknowledgement/negative-acknowledgement methodology of the present invention will be described in the context of the HARQ protocol.

According to one exemplary embodiment of the present invention, a portion of the forward scheduling control channel or forward uplink scheduling channel (F-USCH) providing the scheduling and acknowledgement information for a mobile has the format shown in Table 1.

TABLE 1
The Forward Control Channel Fields

| Field | Length in Bits |
|---|---|
| MAC ID | 8 |
| Encoder Packet Format | 5 |
| Indicator | |
| HARQ Feedback | 2 |
| Reserved | 6 |

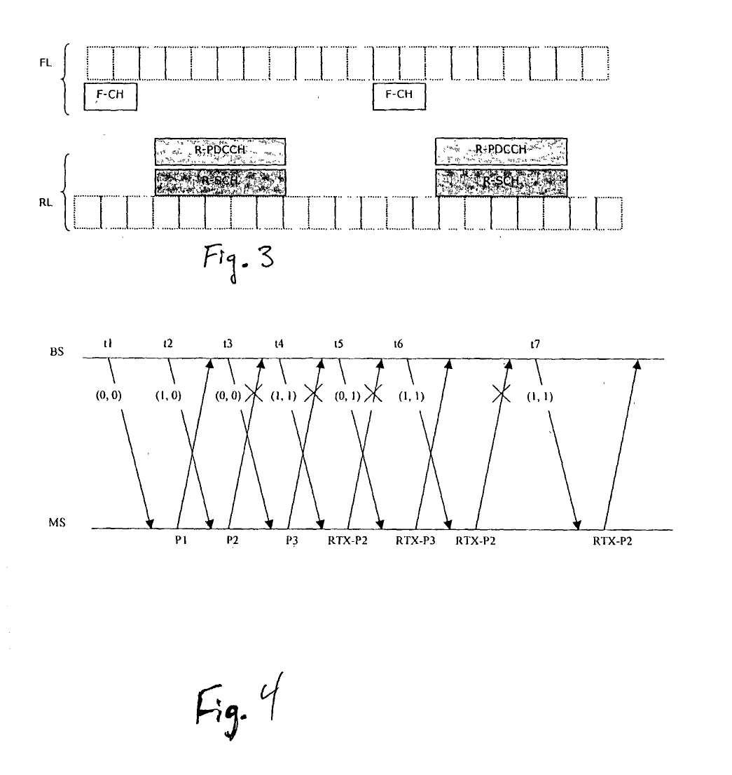

The MAC ID is a well-known mobile identifier, and indicates which mobile station is scheduled to transmit over the reverse link slot associated with the forward control channel slot carrying the information of Table 1. An example of reverse link scheduling on the well-known R-SCH (reverse supplemental channel) is shown in FIG. 3. Note that the mobile needs to receive the forward control channel (e.g., F-USCH) before it can start the transmission on the reverse link. A well-known reverse control channel called R-PDCCH (reverse packet data control channel) containing the information about the transmission rate etc. can also be carried along with the data transmission on R-SCH.

Returning to Table 1, the transmission format provided in the transmission format field indicates the transmission format that the mobile can use while performing the transmission (e.g., the data rate and power level that mobile can use while performing the transmission; however, it should be understood that the transmission format is not limited to this). The HARQ feedback field, as described in detail below, provides the ACK/NACK message for a packet transmitted over a particular HARQ channel by the mobile station.

In this exemplary embodiment, the HARQ feedback information consists of 2-bits (x, y). The first bit ‘x’ indicates whether the transmission is going to be for HARQ channel 0 or HARQ channel 1. The second bit ‘y’ is the ACK/NACK bit or message. A second bit ‘y’ value of ‘1’ indicates a NACK and further indicates the mobile needs to perform a retransmission of the previous packet on the HARQ channel indicated by the first bit. A second bit ‘y’ value of ‘0’ indicates an ACK and further indicates the mobile can perform a new transmission (‘0’) on the HARQ channel indicated by the first bit.

An example operation of the reverse link (RL) HARQ protocol according to this embodiment is depicted in FIG. 4. In order to schedule the transmission of a packet on the reverse link by a particular mobile station (MS), a base station (BS) generates a portion of the forward control channel according to the format specified in Table 1, and transmits the portion of the forward control channel at time t1. The MAC ID in the generated and transmitted portion of the forward control channel identifies the particular mobile station; thus, scheduling transmission by the mobile station. The HARQ feedback information is set as (0,0). The first bit (‘0’) indicates the acknowledgement in the second bit pertains to a transmission on HARQ channel 0, and the second bit (‘0’) acknowledges receipt of a previous packet sent by the mobile station. Because no previous packet was sent by the mobile station on HARQ channel 0, the HARQ feedback information serves to schedule an initial or new transmission on HARQ channel 0. The above described base station processing is performed for each packet scheduled/acknowledged, and this description will not be repeated in this or subsequent embodiments for the sake of brevity. Instead, only the operation differences will be described.

When the mobile station identifies its MAC ID in the forward control channel, the mobile station prepares a packet for transmission based on the data associated with the MAC ID. Namely, as discussed above, the (0,0) HARQ feedback information, instructs the mobile station to send a new packet on HARQ channel 0 during the scheduled transmission. Accordingly, the mobile station generates a new encoder packet P1, and transmits the new encoder packet P1 according to the transmit format indicated in the forward control channel. The mobile transmits the packet P1 in the reverse link slot associated with the forward control channel slot over which the mobile station received its MAC ID. It will be understood that the above described mobile station processing is performed each time the mobile station identifies its MAC ID in a slot of the forward control channel formatted according to the methodologies of the present invention, and this description will not be repeated in this or subsequent embodiments for the sake of brevity. Instead, only the operation differences will be described.

While the mobile station responds with the transmission of packet P1, the base station schedules another packet on HARQ channel 1 in the same manner that packet P1 was scheduled, except that the HARQ feedback information is (1,0).

Assuming the packet P1 on HARQ channel 0 is successfully received, the base station acknowledges successful receipt and thus schedules another packet on HARQ channel 0 by sending HARQ feedback of (0,0) at time t3. Assuming the packet P2 on HARQ channel 1 is received in error, the base station provides a negative-acknowledgement (NACK) and thus schedules a retransmission of this packet by sending HARQ feedback of (1,1) at time t4. Because the second bit indicates a negative-acknowledgement, the mobile station resends the packet P2 instead of sending a new packet.

Assuming the packet P3 is received in error on HARQ channel 0, the base station provides a NACK and thus schedules a retransmission for this packet by providing HARQ feedback information of (0,1) at time t5. If the packet P2 on HARQ channel 1 is again received in error, the base station provides a NACK by sending HARQ feedback information (1,1) at time t6. FIG. 4 then shows that the packet P3 is successfully decoded after one retransmission attempt, and the packet P2 is successfully decoded after three retransmission attempts (a total of four transmission attempts).

As demonstrated above, the methodology of the present invention eliminates the need for a separate ACK/NACK channel. In addition, because the acknowledgement information is provided together with other information such as the scheduling information, error correction coding can be performed on this combined information.

The operation of the forgoing embodiment was described as providing scheduling and acknowledgement information for one mobile station. Similarly, for the sake of clarity and simplicity, the following embodiments are also described using an example of providing scheduling and acknowledgement for one mobile. However, it will be understood that for the above described embodiments and the following embodiments, the scheduling and acknowledgement operation can be conducted for more than one mobile station using the same forward scheduling control channel or more than one forward scheduling control channel.

Also, in the embodiment described above, acknowledgement information was provided for a single HARQ channel and a single packet. This also resulted in the scheduled transmission or retransmission of a single packet over a single HARQ channel. However, the methodology of the present invention is not limited to this. Instead, the methodology of the present invention is applicable to providing acknowledgement information for more than one HARQ channel, for more than one packet in a HARQ channel, or both. Also, the format of Table 1 can be further modified to associate a transmission format with each HARQ channel or with each packet.

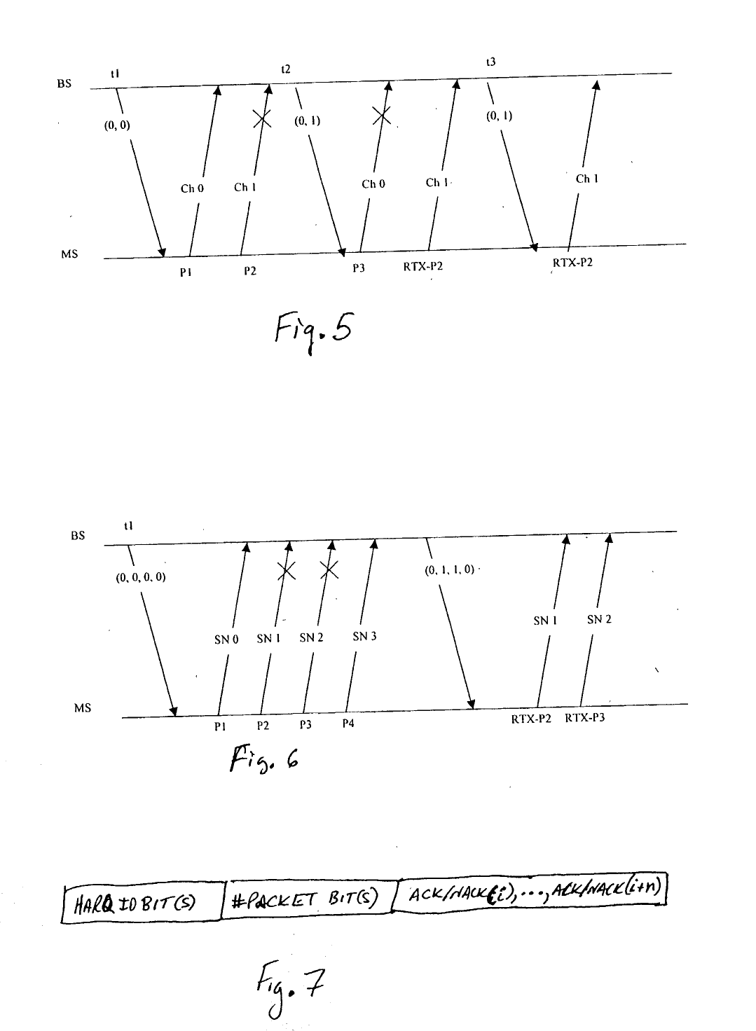

In one exemplary embodiment of the present invention for providing acknowledgement information for more than one HARQ channel of a mobile, the HARQ feedback information of Table 1 consists of 2 bits (i,j), where i represent either an acknowledgement (ACK) and new transmission (‘0’) or a negative-acknowledgement (NACK) and retransmission (‘1’) on Hybrid ARQ channel 0 and j represents either an ACK and new transmission (‘0’) or a NACK and retransmission (‘1’) on Hybrid ARQ channel 1. FIG. 5 illustrates an example operation of the reverse link (RL) HARQ protocol according to this embodiment. In the example of FIG. 5, it is assumed that a particular mobile station wants to send three packets P1, P2 and P3 on the reverse link. At time t1, the base station schedules two new packets on the two HARQ channels by sending (0,0) as the acknowledgment feedback information. In response, the mobile station sends packets P1 and P2 on the reverse link over HARQ channels 0 and 1, respectively. In sending packets to the base station on the reverse link, the mobile station includes the HARQ channel ID (0 or 1) along with each packet. The packet P1 is received properly, but the packet P2 is received in error. The base station provides an ACK of packet P1 and a NACK of packet P2 by sending HARQ feedback information of (0,1) at time t2. This results in the scheduling of a new packet P3 on HARQ channel ‘0’ and retransmission of the packet P2 on channel ‘1’. The packet P2 is again received in error, but the packet P3 is properly received. The base station provides an ACK of packet P3 and a NACK of packet P2 by sending (0,1) as the acknowledgement information. This results in the scheduling of a retransmission for packet P2 on HARQ channel ‘1’. Note that the mobile station does not send any packet on channel ‘0’ because it has no new packets to send.

In the above described embodiment, the HARQ channel for which acknowledgement information was being supplied was implicitly indicated by the position of the ACK/NACK message in the HARQ feedback information. However, the embodiments of the present invention are not limited to this implicit indication of the HARQ channel. Instead, an explicit indication can be provided. For example, in the above embodiment, the HARQ feedback information can include 4 bits. The first bit indicates the HARQ channel to which the ACK/NACK message supplied by the second bit pertains, and the third bit indicates the HARQ channel to which the ACK/NACK message supplied by the fourth bit pertains.

Furthermore, it will be understood that none of the above described or following embodiments are limited to two HARQ channels. Instead the number of HARQ channels involved can be increased by increasing the number of bits used to identify the HARQ channel or by increasing the number bits in the HARQ feedback information implicitly associated with each HARQ channel.

Next, an exemplary embodiment of the present invention providing acknowledgement information for multiple packets in the same scheduling message will be described. In this embodiment, the HARQ feedback information of Table 1 consists of n bits (i₁, . . . , iₙ), where i represent either an acknowledgement (ACK) and new transmission (‘0’) or a negative-acknowledgement (NACK) and retransmission (‘1’) for an nth packet and where n is greater than or equal to 1. FIG. 6 illustrates an example operation of the reverse link (RL) HARQ protocol according to this embodiment. In the example of FIG. 6, it is assumed that a particular mobile station wants to send four packets P1, P2, P3 and P4 on the reverse link, and that the base station provides acknowledgement information for four packets at a time. At time t1, the base station sends the HARQ feedback information of (0,0,0,0) and the mobile transmits four packets. The mobile station then sends packets P1, P2, P3, and P4. As shown in FIG. 6, the sequence number of each packet is sent with the packet, but this is optional. The packets P1 and P4 are properly received, but the packets P2 and P3 are received in error. The base station provides ACKs of packets P1 and P4 and provides NACKS of packets P2 and P3 by sending acknowledgment information (0,1,1,0) at time t2. This results in the scheduling of retransmissions for packets P2 and P3. Therefore, the mobile station retransmits packet P2 and packet P3. Note that even though the acknowledgment information (0,1,1,0) is for four packets, the mobile station only transmits two packets because it has no more packets to send. If the mobile had more packets to send it would have sent, for example, packet P5 and packet P6 in response to the (0,1,1,0) acknowledgment information.

Moreover, the present invention is not limited to implicitly indicating to which packet the acknowledgement information pertains based on the format and position of the acknowledgement information. Instead, a packet to which acknowledgement information pertains can be explicitly provided. Namely, the acknowledgement information can include the sequence number of a packet followed by the ACK/NACK message for that packet. Also, if this embodiment is combined with an embodiment permitting more than one HARQ channel, HARQ channel IDs are not needed when sequence numbers are used in acknowledging packets because the mobile will know by the sequence number which packets were sent on which HARQ channels.

Next, another exemplary embodiment of the present invention for providing acknowledgement information for multiple packets in multiple HARQ channels in the same scheduling message will be described. FIG. 7 illustrates the format of the HARQ feedback bits in Table 1 for this embodiment. As shown, a first sub-field in the HARQ feedback field identifies the HARQ channel. The number of bits needed to identify the HARQ channel will depend on the number of HARQ channels. The next sub-field identifies the number ‘n’ of packets for which acknowledgement information is being provided. The subsequent sub-field provides the ACK/NACK bit for each packet. These three sub-fields are then repeated for each HARQ channel being acknowledged/scheduled for a mobile. If the number of HARQ channels is fixed, then the HARQ ID sub-field can be eliminated because the position of the associated number of packets and ACK/NACK sub-fields can be implicitly associated with a particular HARQ channel. Similarly, if the number of packets is fixed, then the number of packets sub-field can be eliminated as well.

From the forgoing it will be appreciated that numerous formats for providing acknowledgement information over the forward scheduling control channel are possible, and are intended to fall within the spirit and scope of this invention.

The acknowledgement methodology according to the present invention eliminates the need to set aside code space and power for a separate ACK/NACK channel. Instead, scheduling and acknowledgement information are provided over the same forward control channel. Furthermore, a reliable acknowledgement/negative-acknowledgement feedback transmission is provided because the feedback information is coded along with the other forward control channel information.

The invention being thus described, it will be obvious that the same may be varied in many ways. Such variations are not to be regarded as a departure from the spirit and scope of the invention, and all such modifications are intended to be included within the scope of the following claims.

We claim:

1. A method of managing packet transmission by a mobile, comprising:
transmitting a forward control channel that includes scheduling information and acknowledgement information, the scheduling information scheduling transmission by a mobile and the acknowledgement information indicating successful or unsuccessful receipt of at least one packet sent by the mobile.

2. The method of claim 1, wherein the forward control channel includes scheduling and acknowledgement information for more than one mobile.

3. The method of claim 2, wherein the scheduling information includes a mobile identifier identifying the mobile scheduled to transmit, and the acknowledgment information being associated with the scheduling information such that the acknowledgement information pertains to at least one packet sent by the mobile identified by the mobile identifier.

4. The method of claim 3, wherein
packets are received from a mobile over more than one packet transmission channel; and
the acknowledgement information indicates at least one packet transmission channel to which the acknowledgement information pertains.

5. The method of claim 4, wherein the acknowledgement information includes an ACK/NACK indication according to the HARQ protocol.

6. The method of claim 4, wherein the acknowledgement information further indicates which packet transmission channels are scheduled for a new transmission and which packet transmission channels are scheduled for a re-transmission.

7. The method of claim 4, wherein the forward control channel includes a packet format indicator in association with each mobile identifier to indicate a data rate and power level at which to transmit the scheduled packet.

8. The method of claim 3, wherein
packets are received from a mobile over more than one packet transmission channel, and
the acknowledgement information indicates successful or unsuccessful receipt of packets sent by the mobile over more than one packet transmission channel.

9. The method of claim 8, wherein the acknowledgement information further indicates which packet transmission channels are scheduled for a new transmission and which packet transmission channels are scheduled for a re-transmission.

10. The method of claim 8, wherein the acknowledgement information indicates successful or unsuccessful receipt of more than one packet sent over a same packet transmission channel.

11. The method of claim 10, wherein the acknowledgement information identifies a packet to which the acknowledgement information pertains by identifying a sequence number of the packet.

12. The method of claim 3, wherein the acknowledgement information indicates successful or unsuccessful receipt of more than one packet sent over a same packet transmission channel.

13. The method of claim 12, wherein the acknowledgement information identifies a packet to which the acknowledgement information pertains by identifying a sequence number of the packet.

14. The method of claim 1, wherein
packets are received from a mobile over more than one packet transmission channel; and
the acknowledgement information indicates at least one packet transmission channel to which the acknowledgement information pertains.

15. The method of claim 1, wherein the forward control channel includes a packet format indicator in association with each mobile identifier to indicate a data rate and power level at which to transmit the scheduled packet.

16. The method of claim 15, wherein the acknowledgement information further indicates which packet transmission channels are scheduled for a new transmission and which packet transmission channels are scheduled for a re-transmission.

17. The method of claim 1, wherein the acknowledgement information identifies a packet to which the acknowledgement information pertains by identifying a sequence number of the packet.

18. The method of claim 1, wherein the generating step generates the forward control channel to include a packet format indicator to indicate a data rate and power level at which to transmit the scheduled packet.

19. The method of claim 1, further comprising:
generating the forward control channel.

20. A method of managing packet transmission by a mobile, comprising:
receiving a forward control channel that includes scheduling information and acknowledgement information, the scheduling information scheduling packet transmission by a mobile and the acknowledgement information indicating successful or unsuccessful receipt of at least one packet sent by the mobile; and
transmitting a packet based on the received scheduling and acknowledgement information.

21. The method of claim 20, wherein the transmitting step transmits at least one packet if the scheduling information indicates that the mobile is scheduled to transmit at least one packet and the mobile has at least one packet to send.

22. The method of claim 21, wherein the transmitting step transmits a new packet if the acknowledgement information indicates successful receipt of a packet sent by the mobile and the mobile has at least one packet to send.

23. The method of claim 22, wherein the transmitting step re-transmits a packet if the acknowledgement information indicates unsuccessful receipt of a packet sent by the mobile.

24. The method of claim 23, wherein the acknowledgement information is an ACK/NACK indication according to the HARQ protocol.

25. The method of claim 23, wherein
the acknowledgement information indicates at least one packet transmission channel to which the acknowledgement information pertains; and
the transmitting step transmits over the indicated packet transmission channel if the scheduling information indicates that the mobile is scheduled to transmit and the mobile has at least one packet to send.

26. The method of claim 25, wherein the transmitting step transmits a new packet when the acknowledgement information indicates successful receipt of a packet sent by the mobile and the mobile has at least one packet to send.

27. The method of claim 25, wherein the transmitting step re-transmits a packet when the acknowledgement information indicates unsuccessful receipt of a packet sent by the mobile.

28. The method of claim 21, wherein the scheduling information indicates a mobile is scheduled to transmit a packet by including a mobile identifier of the mobile.

29. The method of claim 21, further comprising:
receiving a packet format information in association with the scheduling and acknowledgement information, the packet format information indicating a data rate and power level at which to transmit; and wherein
the transmitting step transmits a packet at the indicated data rate and power level if the associated scheduling information indicates that the mobile is scheduled to transmit and the mobile has at least one packet to send.

30. The method of claim 21, wherein
the acknowledgement information indicates at least one packet transmission channel to which the acknowledgement information pertains; and
the transmitting step transmits over the indicated packet transmission channels if the scheduling information indicates that the mobile is scheduled to transmit and the mobile has at least one packet to send.

31. The method of claim 30, wherein the transmitting step transmits a new packet when the acknowledgement information indicates successful receipt of a packet sent by the mobile and the mobile has a packet to send.

32. The method of claim 30, wherein the transmitting step re-transmits a packet when the acknowledgement information indicates unsuccessful receipt of a packet sent by the mobile.

33. The method of claim 30, wherein
the acknowledgement information indicates more than one packet transmission channel to which the acknowledgement information pertains; and
the transmitting step transmits at least one packet over the indicated packet transmission channels if the scheduling information indicates that the mobile is scheduled to transmit and the mobile has packets to send.

34. The method of claim 30, wherein
the acknowledgement information includes acknowledgement information for more than one packet sent over a same packet transmission channel; and
the transmitting step transmits more than one packet over at least one of the packet transmission channels if the scheduling information indicates that the mobile is scheduled to transmit and the mobile has packets to send.

35. The method of claim 30, wherein
the acknowledgement information includes acknowledgement information for more than one packet; and
the transmitting step transmits more than one packet if the scheduling information indicates that the mobile is scheduled to transmit and the mobile has packets to send.

36. A method of managing packet transmission by a mobile, comprising:
transmitting a forward control channel that includes first scheduling information and second scheduling information, the first scheduling information scheduling transmission by a mobile and the second scheduling information indicating whether to transmit a new packet or retransmit a previously transmitted packet.

37. A method of managing packet transmission by a mobile, comprising:
receiving a forward control channel that includes first scheduling information and second scheduling information, the first scheduling information scheduling transmission by a mobile and the second scheduling information indicating whether to transmit a new packet or retransmit a previously transmitted packet; and
transmitting a packet based on the received first and second scheduling information.
